(19) United States
(12) Patent Application Publication
(10) Pub. No.: US 2010/0274708 A1
(43) Pub. Date: Oct. 28, 2010

(54) APPARATUS AND METHOD FOR CREATING A COLLATERAL RISK SCORE AND VALUE TOLERANCE FOR LOAN APPLICATIONS

(76) Inventor: Lewis J. Allen, Riverside, CA (US)

Correspondence Address: BORTON PETRINI, LLP, 5060 CALIFORNIA AVENUE, 7th FLOOR, BAKERSFIELD, CA, 93309, US

(21) Appl. No.: 12/435,974

(22) Filed: May 5, 2009

Related U.S. Application Data
(60) Provisional application No. 61/056,943, filed on May 29, 2008.

(51) Int. Cl. G06Q 40/00

(52) U.S. Cl. 705/38

(57) ABSTRACT

A computer implemented system for converting loan risk and property database information into a risk-adjusted value and report comprising software modules configured with instructions to retrieve electronic property value data from one or more electronic property value and property characteristic databases and calculate a property value estimate, loan risk value, property value, and loan risk value estimates; and producing a report with a collateral risk score. The invention also comprising a module for calculating a variance based on the combined collateral risk score conditions approval of an electronically submitted evaluation order based on whether a given qualifying value falls within the calculated variance. The invention further comprising a software module with instructions to calculate the percentage of difference between the qualifying value and a limit of the calculated variance.

### CROSS REFERENCE TO RELATED APPLICATIONS

This application claims the benefit of U.S. Provisional Application No. 61/056,943 filed May 29, 2008.

### FEDERALLY SPONSORED RESEARCH

Not Applicable

### SEQUENCE LISTING OR PROGRAM

Not Applicable.

### BACKGROUND OF THE INVENTION

1. Field of the Invention

The invention and its various embodiments disclosed herein relate to the valuation of real property. More particularly, the invention and its various embodiments relate to a method and process that systematically establishes a risk-adjusted value applicable to a statistically derived estimate of value. The collateral valuation reports incorporate known property and user data to create a unique value conclusion and risk score analyzed for acceptance or denial.

2. Description of Related Prior Art

In conventional loan programs, the degree to which the property value can be flexed to meet a specific qualifying value is an arbitrary determination applied by the appraiser, who may be under pressure from the loan agent or broker to produce the required value in an appraisal report.

Further, conventional appraisal valuation processes neither adequately, nor consistently quantifies collateral risk at the individual loan level. Since their introduction in the mid-1990s, automated valuation models (AVM) applications have improved significantly, although by themselves, they fall short of providing a comprehensive collateral risk solution and rely only on structural and other criteria that are intrinsically tied to the property to achieve the appraisal value.

What is needed is a systematic, objective, automated risk-based determination of value tolerance, wherein consistent rules are applied to eliminate loan agent influence, while generating data that helps derive a collateral risk score, which is the relationship between a qualifying value and a value tolerance range or variance. The results of the loan risk-scoring analysis can then be used to calculate a value tolerance, the degree to which the value estimate can be flexed to accommodate the qualifying value or sales price submitted in the loan application.

This process can be applied when valuation is an issue at any level of the loan history, from origination to portfolio analysis to asset management.

### SUMMARY OF THE INVENTION

In accordance with the invention, a problem of relying on lender-influenced appraisal reports is solved by providing a computer program configured to accept and analyze risk factors and property information to establish an automated collateral risk evaluation report.

This problem is also solved by an additional embodiment that retrieves historical property value information from property databases, retrieves property improvement data, includes property geographic centric information, calculates a property value estimate; accepts input of loan risk factors to create a loan risk value estimate; calculates and creates a combined collateral risk score based on a combination of the property value estimate and the collateral risk score; calculates a variance based on the combined collateral risk score; and conditions approval of an evaluation order based on whether or not a specified qualifying value falls within a variance.

Additionally, another embodiment may prepare a collateral risk evaluation report identifying user information, property information, a variance, appropriate verification if necessary is identified and approval or disapproval of the evaluation order.

### BRIEF DESCRIPTION OF THE DRAWINGS

FIG. 1 is a process flow diagram illustrating a data collection and verification and a collateral risk evaluation process for generating a collateral evaluation report.

FIG. 2 is a process flow diagram of a collateral evaluation report order, process, and either originally submitted or re-submitted after a prior collateral risk evaluation.

FIG. 3 is a process flow diagram showing a method for confirming status, errors, and other potential duplications or errors in the collateral evaluation order.

FIG. 4 is a process flow diagram showing dual, logical components for evaluating the appraisal request.

FIG. 5 is a schematic tree of sample vendor data used to determine collateral evaluation variance scores.

FIG. 6 is a block diagram showing a method for assigning variances based on calculated appraisal scores.

FIG. 7 is a block diagram for comparing multiple property criteria against a trusted property database for submission to a collateral risk evaluation software engine.

FIG. 8 is a process flow diagram showing a collateral risk evaluation program requiring multiple conditions for validating previously submitted appraisals.

FIG. 9a is a process flow diagram for ordering a risk-adjusted verification of a property.

FIG. 9b is a continuation of the process flow diagram from FIG. 9a for ordering a physical inspection when required by the risk analysis process of a property

FIG. 10a is a process flow diagram showing a method for reviewing a collateral risk evaluation submitted after being approved for property inspection.

FIG. 10b is a block diagram showing possible collateral risk evaluation method and system features.

FIG. 11a illustrates a page displaying.

FIG. 12 is a statistical illustration and diagram of a value tolerance range with related data.

FIG. 13 is a network schematic of a collateral risk evaluation system integrated with an internet accessible.

### DETAILED DESCRIPTION OF THE DRAWINGS AND PREFERRED EMBODIMENTS

A complete understanding of this invention can be gained through reference to the drawings in conjunction with a thorough review of the disclosure herein.

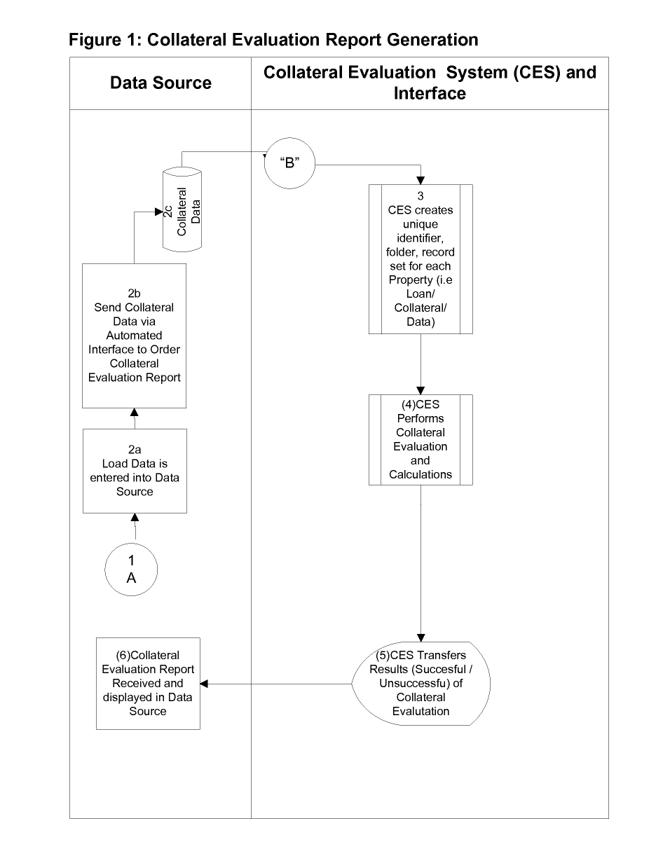

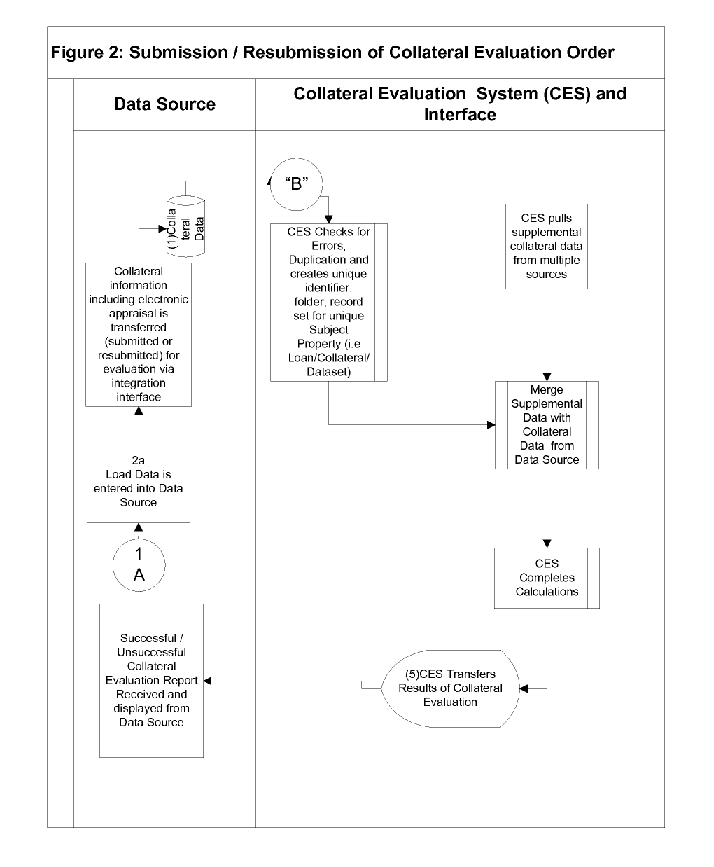

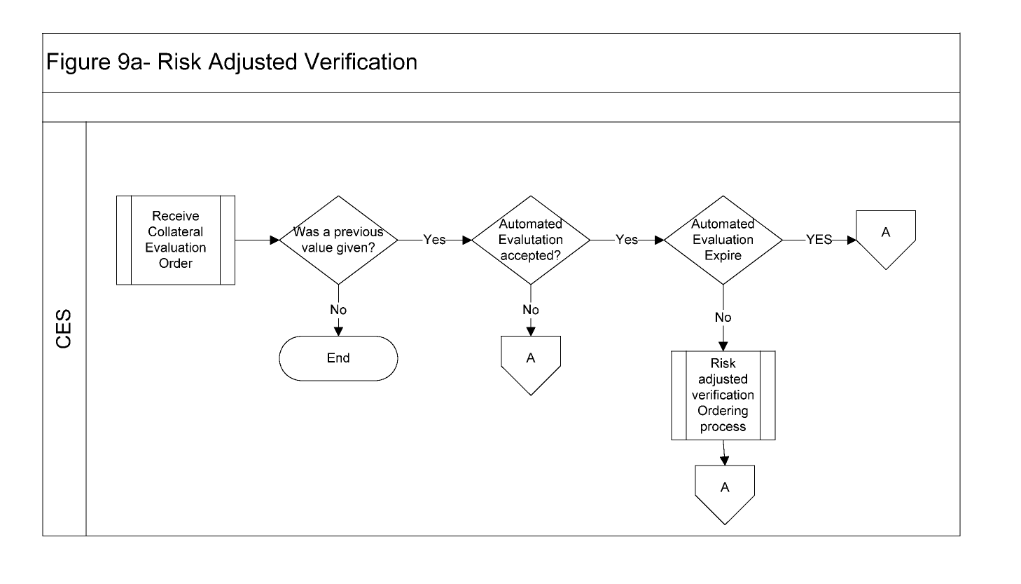

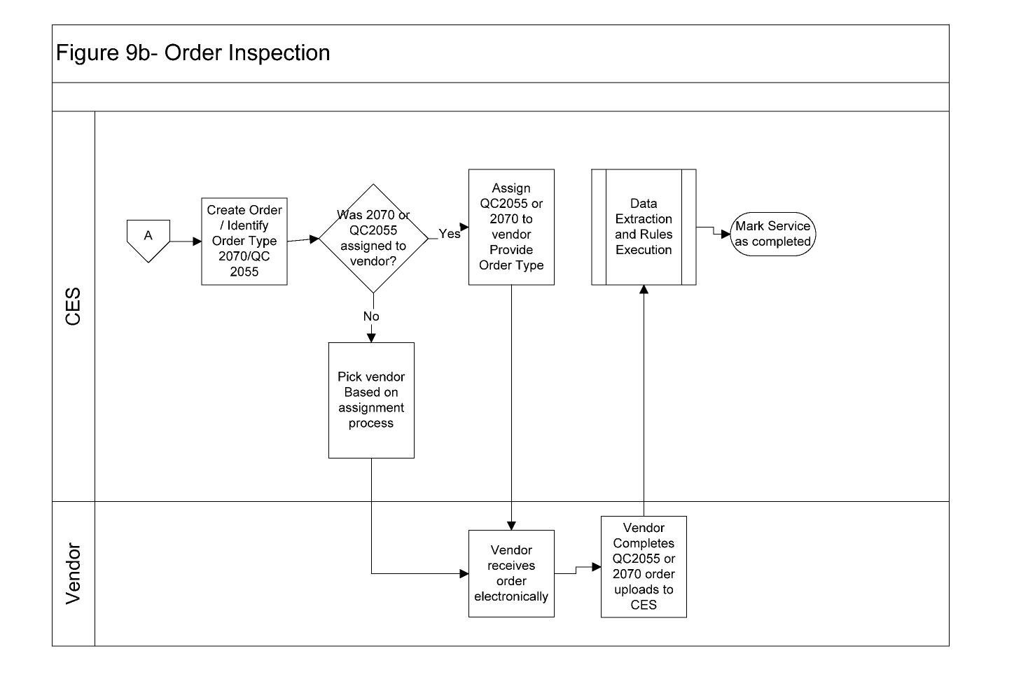

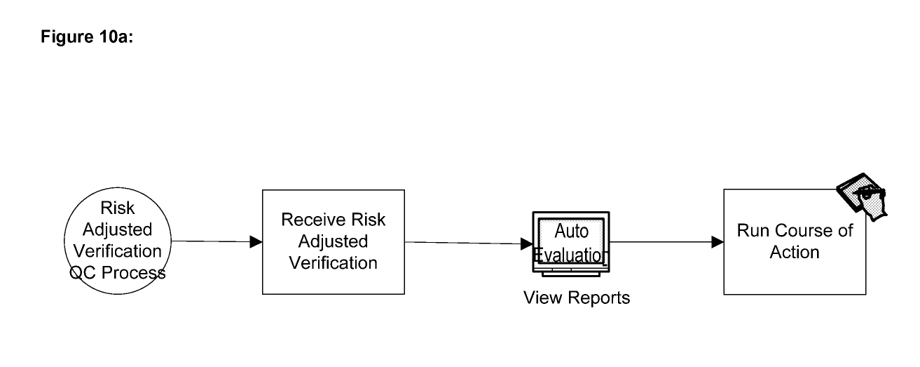

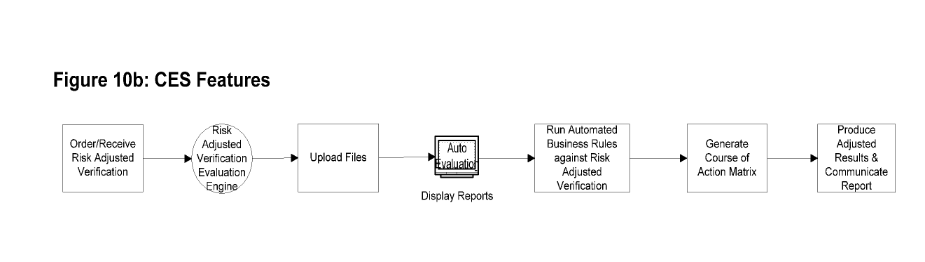

In general, and as an exemplary embodiment is illustrated at a process level in FIGS. 1-4, and 6-10. Shown in FIGS. 1-4, 8, and 9, users order an automated collateral risk evaluation report designated generally as point “A” 1 by logging onto a system or integrating with a system, designed to allow a user to enter basic property and/or loan information about a transaction 2a. Upon submission, and after confirming order information, status checks, and duplicate collateral evaluation are checked through a preliminary step of the collateral risk evaluation system (hereinafter referred to generally as, “CES”) 2b 2c. After initial validity checks, CES performs a calculation process 3 4 in which multiple automated valuation model (“AVM”) values are combined with other data and a plurality of risk-associated factors which are incorporated into a novel algorithm that creates a specific value and variance for determining the allowability of the user defined value falling within that variance. Once processed, a CES report is transferred to a designated person or entity 5 which is then received 6 and the user then has the option of accepting or declining the collateral risk evaluation within a designated period of time, and after which, the order may then expire. If accepted, a risk-adjusted verification is ordered 7 or, other, supplemental criteria can be proffered or may be submitted to the user or a third party and then undertaken for further review.

A report is either a visual display (e.g., on a web page), an electronic report that can be downloaded to a storage medium or printed, or transmitted (usually electronically) and viewed through an application.

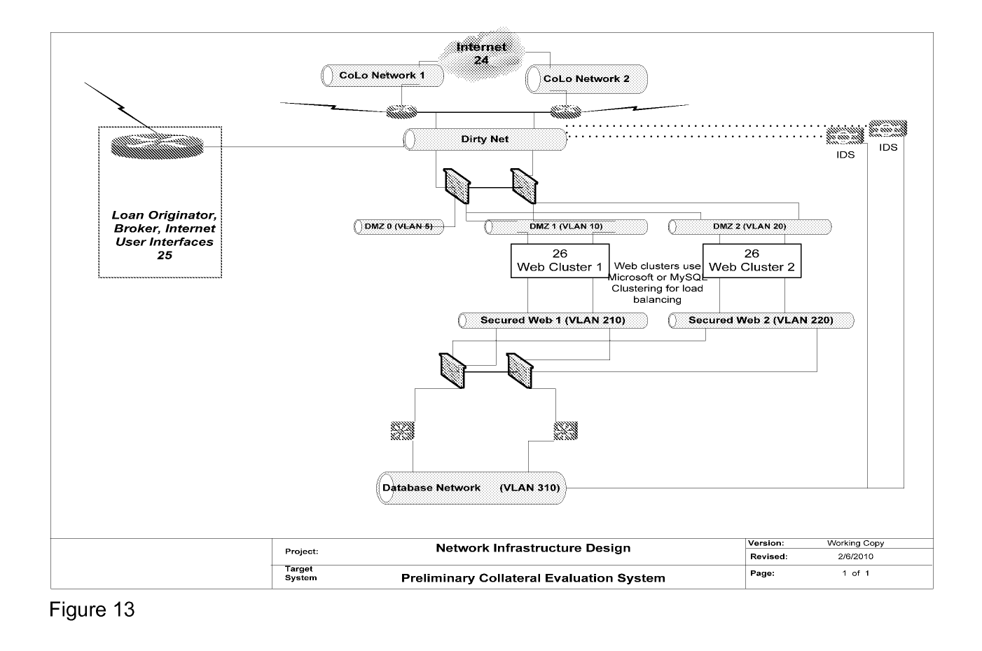

Web-Based Access: Preferably, the collateral risk evaluation system 24 may be embodied as shown in FIG. 13. In FIG. 13 users may access a CES module 25 from a web browser having the ability to store and display communication in the form of a web page or other connection, interfacing with web server(s) or cluster 26 that control the CES processes.

Alternate network embodiments are also possible. For example, a client program could be accessed from any wireless or non-wireless device capable of storing and running a program that can access the proposed method, system, or executed and run from a standalone application. These devices include personal digital assistants, (PDA's) laptops, cellular phones, or other remote computing devices through a web browser-based interface or from a direct connection such as a Virtual Private Network. (VPN). A batch process is also available in which properties are submitted in bulk in a spreadsheet or other media for evaluation.

Alternately, Collateral Evaluation Software processes may also be stored on any form of machine readable medium and subsequently installed or loaded as an application capable of receiving application updates either through other machine readable media or, dynamically, through server updates through the internet or direct network connections.

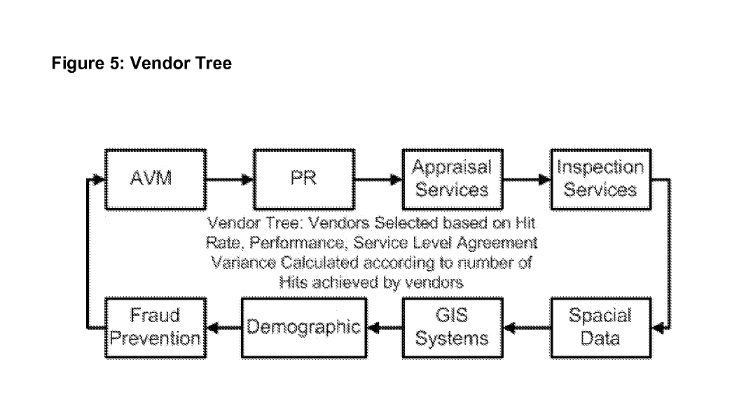

Preferably, and as will be explained below, AVM and collateral risk qualifying criteria used to create weighted scores and used in conjunction with one or more of the above described systems, methods, or devices, may be internally stored data using one or more databases. Types of stored data may include information from third party vendors (See, FIG. 5) such as credit information suppliers, property valuation suppliers, property information suppliers, loan providers and other data necessary for the CES process. Access to AVM and other databases can preferably be accomplished according to FIG. 13 with one or more CES servers 20 providing internal processes for running CES software, storing necessary information, and retrieving through known connections third party information required for appraisal evaluation as needed. For example, externally retrieved data could be AVM data, property information, or credit information from third party credit information suppliers.

Alternatively, and as data is subsumed or stored locally by the CES server(s) databases as shown in FIG. 13 can be local to the CES server(s) or as part of an active directory or domain to provide access to data internally to a local network or, as part of a trusted domain.

To order a collateral risk evaluation report users may log into a network running the CES software 1 and access an order page to enter basic information about the order. Access and login can be verified through known secure, encrypted login processes. Upon submission, the CES process obtains reports from, typically, 1 to 5 AVM vendors and other data to arrive at the property value and subsequent range based on CES specific risk parameters. The user then has the option of accepting or declining the CES evaluation. Users and other relevant third parties having an interest in the CES evaluation will be able to accessing the CES system or device.

If the submitted information is submitted through an online or Internet accessible browser or other connection, the information is communicated to one or more servers running the CES process.

If the submitted information is submitted in response to an installed or locally accessible application, the submitted information can be either processed through local application processes or in a distributed process network environment where known methods can be used to update the system or application.

To begin a Collateral Evaluation order, the CES process preferably requires information pertaining to the property at issue and other loan risk related information. A sample table is provided below and mimics database fields assigned to each piece of identifying information and used in the risk scoring detailed later:

| Field Description | Include? |
|---|---|
| Branch | Yes |
| Underwriter | No |
| Account Manager | No |
| Account Executive | No |
| Prequalification | No |
| Indicator | |
| Loan Number | Yes |
| Loan Amount | Yes |
| CPI Number | No |
| LTV | No |
| CLTV | Yes |
| Loan Purpose | Yes |
| Origination Source | Yes |
| Documentation Type | Yes |
| Borrower First Name | Yes |
| Borrower Last Name | Yes |
| Borrower Home Phone | No |
| Borrower Alt Phone | No |
| Property Address | Yes |
| City | Yes |
| State | Yes |
| Zip | Yes |
| Property Type | Yes |
| Appraisal Amount | No |
| Occupancy | Yes |
| Instructions to | No |
| Appraisal | |
| Estimated Value | Add this field |
| FICO Score | Add this field |

Once a user enters information they can then be prompted to submit the order and/or to confirm or otherwise authenticate the submitted information. In a preferred embodiment a unique identification may be assigned to each user or order so as to capture and identify the order at later stages of the CES process and for reporting purposes.

The user ID of the person submitting the order may be captured through known methods for creating and assigning a unique identification into a field on a relational database for joining to related order or other information.

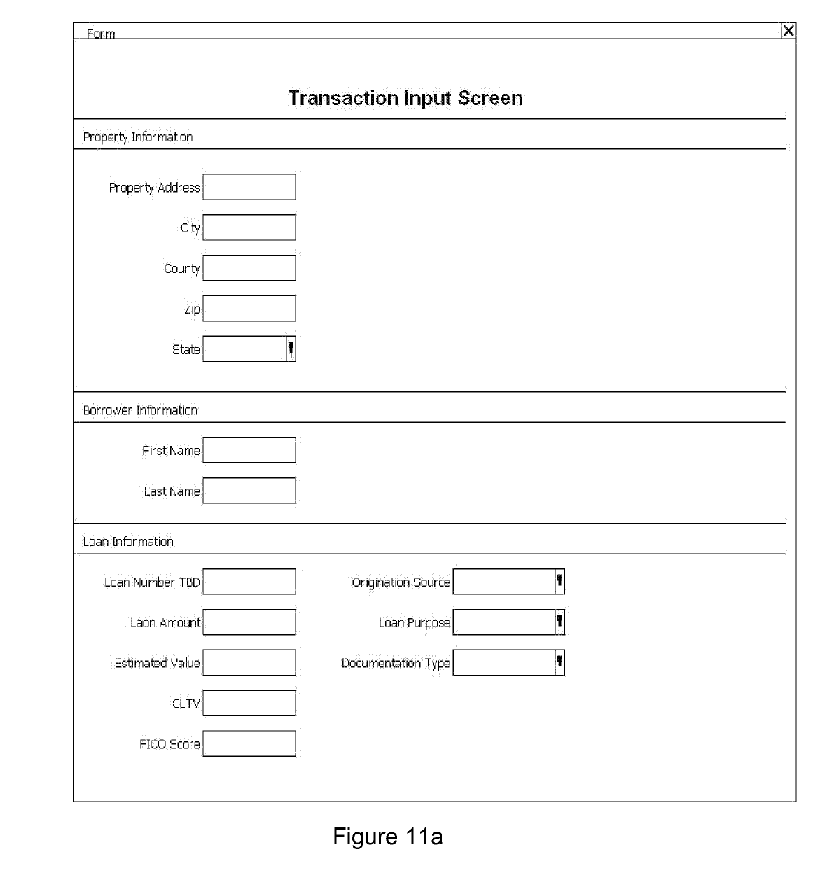

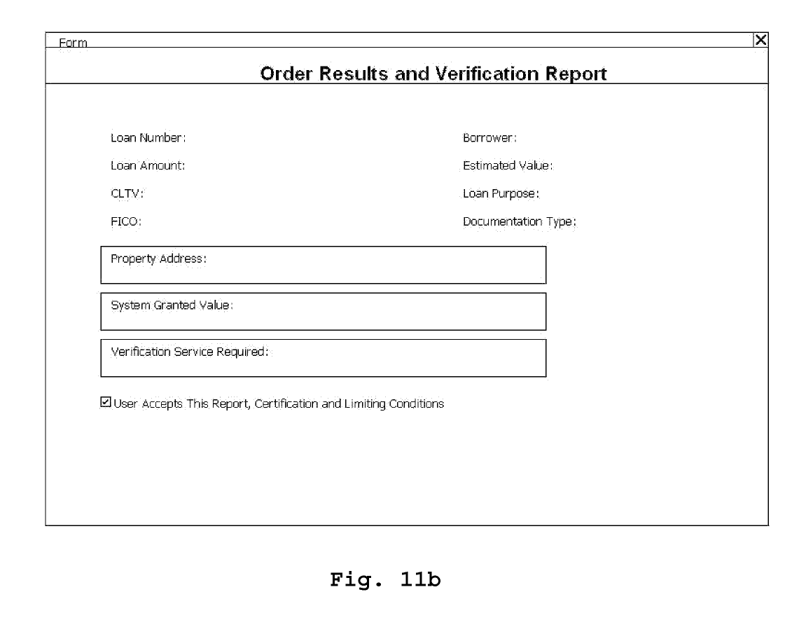

Confirmation screens (see, FIG. 11b) may also prompt the user for the acceptance of the order and/or to display the information entered by the user and allowing them to edit their order before final submission.

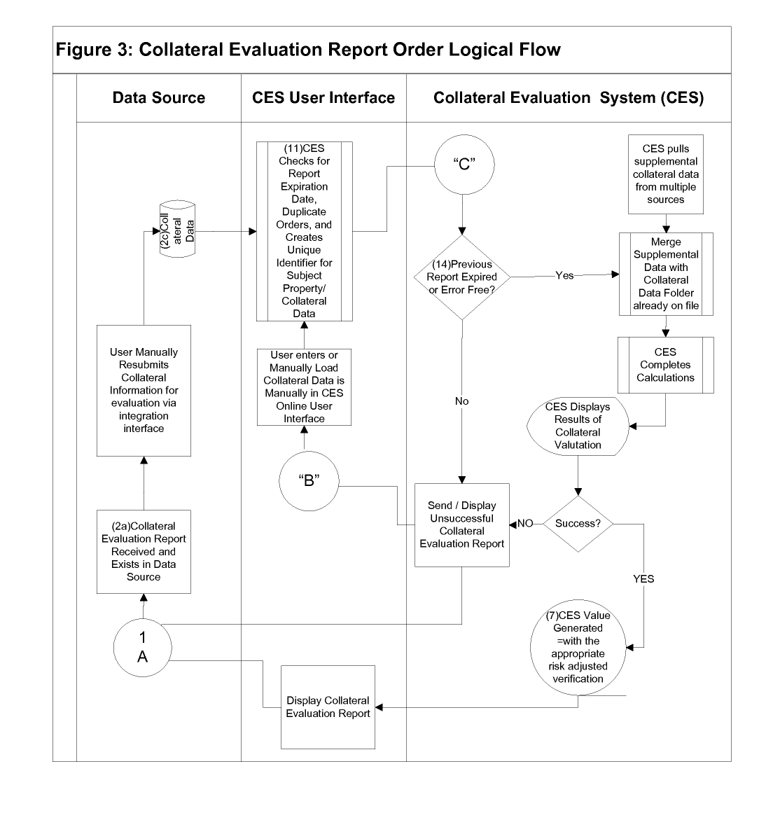

It is preferred that a series of confirmation and validation checks be run before running the CES calculations 11. FIG. 3 is illustrative, but not as a limitation, of how CES validation can occur:

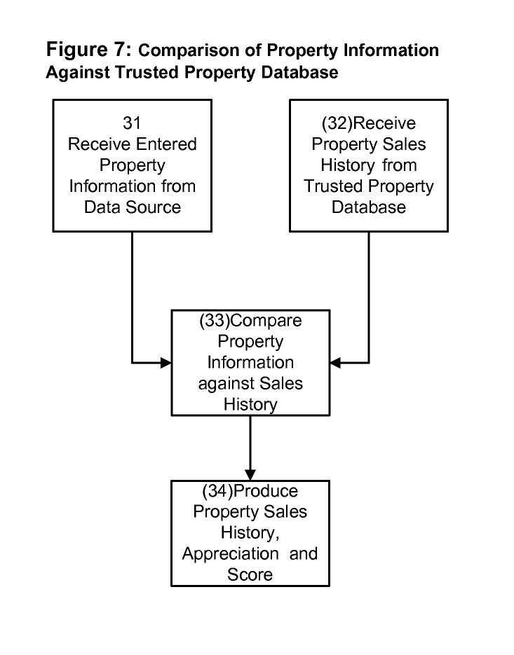

After an order and related information are submitted 10 by a user, CES first begins searching one or more databases for a matching order 11; if a matching order is not found, CES begins calculations for generating a report 4; if a matching order is found, a series of duplication checks are performed such as whether a previous CES has been uploaded 30, and how old or how long the order has been open 14, and finally whether or not the valuation is stale in a rapidly appreciating market 33. (FIG. 7) If any of the responses to the validation and duplication checks pass, the order will be run through the CES algorithm. If the checks fail, the order fails.

If a previous valuation exists within the system, the CES engine will perform a check of the appreciation of the property's value. For example, Max Value=Previous Appraisal Value*(1+0.015)̂(Appraisal Age in Months). The system will check that the requested value is less than the maximum value calculated above.

On a daily basis, the system may check the outstanding orders to ensure that they have not reached an age causing them to become invalid. Those orders that have become outdated will be automatically cancelled by the system.

Future modifications may include comparison of outside data sources.

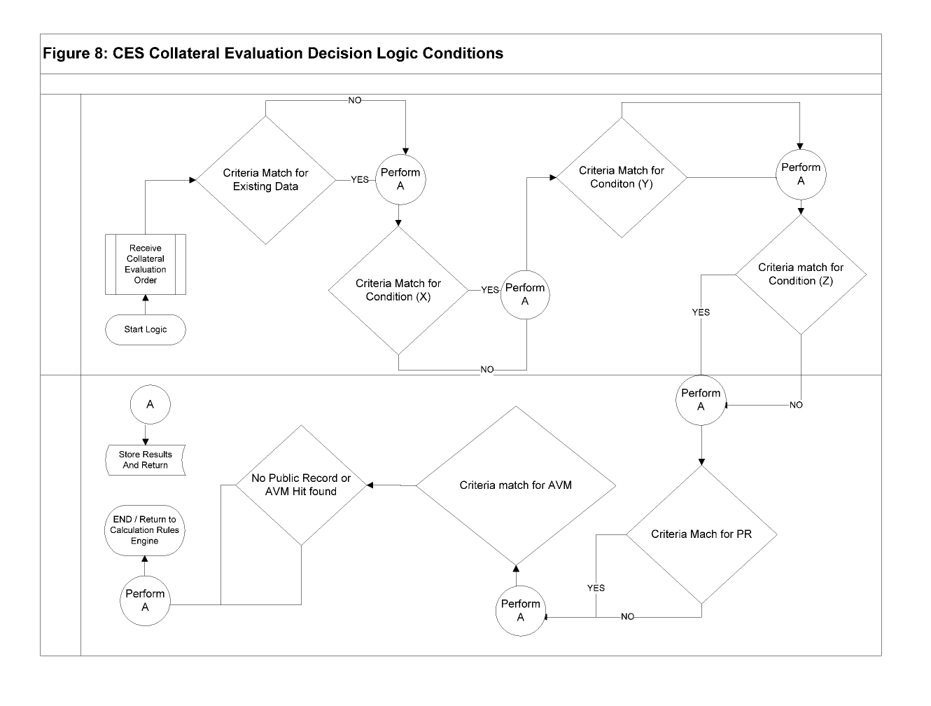

In general, any number of computer-implemented specified confirmation or validation checks can be implemented as conditions precedent to a CES report. (See, FIG. 8)

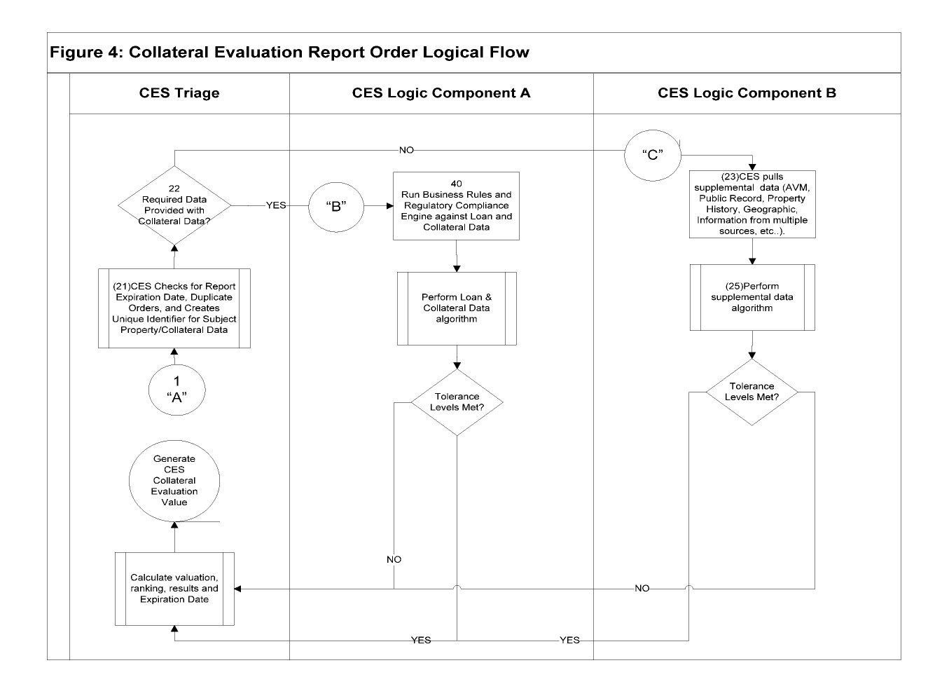

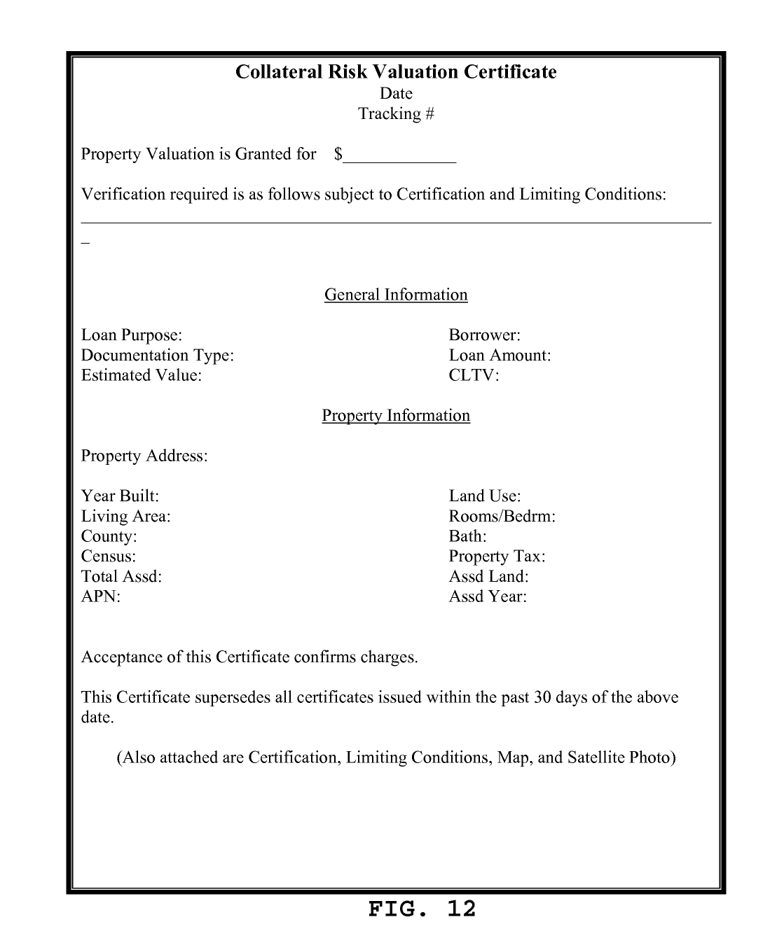

A Collateral Evaluation, for the purposes of this invention, and as illustrated as an overview in FIGS. 1-4 is a final report on the overall calculated value based on property value and risk-related scores. Property value estimates 31 32 are entered into a proprietary risk-scoring model in which a loan is also graded for risk, and a final value estimate is derived. The score generated by the model creates a value variance or value tolerance (FIG. 12) or, the degree to which the estimate of property value can be adjusted to accommodate a stated or qualifying value. If a qualifying value (the amount of funding needed or requested by the borrower from the lender) falls within or below the value tolerance range, a CES ‘certificate’ (used herein as a symbol word for any number of ways in which an order that succeeds in falling within the variance is communicated to an order requestor) is issued. The CES scoring algorithm requires two classes of information before performing its calculations. As described in FIG. 4, after an order is submitted at point A, 1 the CES process retrieves AVM property appraisal data and retrieves loan risk data. (Typically AVM and loan risk data are retrieved from third party vendors but it is expected that as the CES process expands, these could be acquired as internal databases)

FIG. 4 illustrates a preferred embodiment where multiple AVM vendors are queried to create a value estimate around which a calculated variance will be applied. It is preferred that a plurality of vendor data such as those shown in FIG. 5 are retrieved 23 and a sampling of that data is analyzed to create a representative value estimate 25. In a preferred embodiment, five AVM vendors are queried and analyzed to determine their credibility and acceptance before any omissions are made before the final calculation is determined. The final value estimate is submitted as one of several weighted parameters in an overall collateral evaluation score, with the remaining weighted score parameters resulting from the loan risk factors disclosed below.

Verifying AVM values: The values produced by the appraisal AVM cascade can be supplemented or verified using data sources external to the appraisal process and as shown in FIG. 7 and which can be factored into the overall score of the subject property. Specifically, the validations may but are not limited to include:

A review of the subject property's history to ensure that the subject's price appreciation rates are within normal tolerances for the community, property type and price band;

A comparison may also be made of the final AVM value to the subject property's tax assessed value, and which has been adjusted at the tax jurisdiction level to reflect market value. This comparison will ensure that the subject property's value is within acceptable tolerances;

A statistical sampling method to show that the sample being tested is representative of the total population;

Comparison of value estimates and value tolerance ranges to external collateral assessment programs, which will include a combination of desk review and drive-by appraisals;

Periodic analysis of a sample of properties to make sure that the business process is stable and is not unduly influenced by special causes that cannot be attributed to natural variations; and

Process changes to ensure that the collateral assessment process is working to the design specifications.

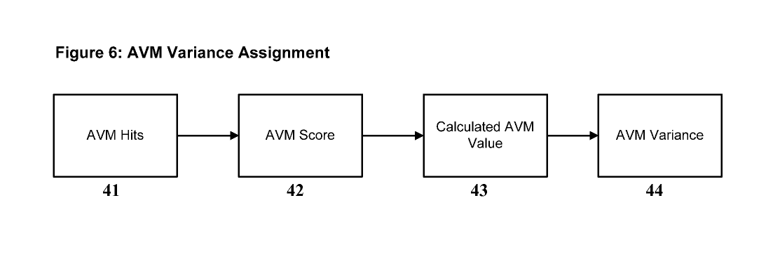

The risk-scoring model is a rules-based system that employs determinative variables for assessing loan performance based on a borrower's credit risk combined with property value estimates. The initial scoring model calculates a loan-level risk score based on these variables. Acceptable determinative variables include but are not limited to: borrower credit score, property location, loan amount, qualifying value (stated value or sales price), Current Loan to Value Ratio (at the qualifying value), loan purpose, value estimates (Typically produced by independent AVM products), or variance between the AVM values. As illustrated in FIGS. 5 and 6, weighted risks (FIG. 5) are retrieved and each given a score 42 based on its overall effect on risk 43 and then an AVM variance is calculated 44.

For example, FIG. 5 shows weighted scores given for the type of loan, creditworthiness, combined loan to value ratio (“CLTV”), geography, loan amount, and sales history. The sum of these scores are added or otherwise multiplied and added to the AVM score and property characteristic ratio score for a combined total score. The combined scoring is then applied to a predetermined scoring model as illustrated as an overview in FIG. 6 whereby a combined total score that falls at or above a specified value will be assigned a variance based on the combined score. In FIG. 6, and only as an example and not as a limitation, if combined scores 42 have combined totals at or above 800, they are given an allowable variance 44 of 15%. However, the uppermost variance range can change depending on market conditions, lender preferences, and other factors. In this way, lower combined scores will yield lower variances whereby a lender can base its lending decision based on the property value and flexibility in its decision-making based on loan risk factors.

Additionally, as specific loan performance detail is acquired, a rules-based risk-scoring model may transition to a regression-based model.

As an example of how a risk-based variance is applied to a qualifying value estimate, assume a property with estimated value ranges of $300,000 to $385,000 and with an estimated value of $345.000 as determined by CES after analysis of relevant property data. The CES risk scoring algorithm based on selected and weighted risk-associated factors gives the estimated average loan value a variance of 8% or, a range from $317,000 to $372,600 within which the loan provider can flexibly provide “headroom” to accommodate an agent's proposed qualifying value. As a result, if the qualifying value is $400,000 the lender can decline the loan. On the other hand, a loan of $372,000 will be approved since it falls within the value tolerance range.

Therefore, if the qualifying value falls within or below the value tolerance range, the qualifying value submitted by the loan agent may then be accepted and granted. If the loan agent's qualifying value exceeds the value tolerance range, the application will be denied.

The CES scoring model is also flexible enough to provide for those qualifying values that exceed or fall below the variance threshold by a nominal percentage. For example, if the qualifying value in the above example was $380,000 and, thus, fell outside of the upper limit of the value tolerance range, a further calculation can be performed where if the qualifying value exceeds or falls below the value tolerance range by a selected small percentage, the order may either be approved or, submitted for further administrative review.

Properties processed through the CES process will be analyzed for the appropriate risk adjusted verification process. This process includes the option that the property be subjected to an inspection by an approved and/or licensed appraiser. Further safeguards may also be implemented such as:

All properties with improvements older than 40 years can receive an interior inspection, as can a selection of properties with improvements newer than 40 years based on a risk-score threshold. To, prevent loan agents from securing the highest possible valuation amount CES will preferably reserve the top percentage of the value tolerance range when the qualifying value exceeds the range. In this way, loan agents will never receive (or know) the upper limit of the value tolerance range and so prevents artificial inflation/deflation of the qualifying value.

To prevent loan agents from submitting multiple hits for the same property to secure progressively higher valuation amounts, it is also preferred subject properties will be eligible for the program once in a 30-day period and whereby multiple submissions within a 30-day period will be rejected.

The performance of loans generated through the system will be monitored to ensure the program is working to design specifications. This includes loan agent-level tracking to identify potential fraud or gaming issues

Once a Collateral Evaluation is approved by CES, further information may be required by the lender, local, state, or federal guidelines. In such a case, CES software designates the order as pending while necessary information such as lender forms, documents, or inspections are filled out performed, and submitted either for subsequent calculations of manual review. For example, users can be presented with a streamline process for placing orders for the Freddie Mac 2070 inspections with designated vendors.

Once an inspection or all other necessary documents are completed and submitted to CES, the order can then be routed to an originating location or other designated recipient for final review or approval.

In a further addition to the above calculations, a further criterion of requiring a certain level of inspection to be performed to determine the overall viability of the approved valuation. As an example and not to be construed as a defined limitation, if a Collateral Evaluation Certificate is granted, the following table can be used to determine whether the property will have an interior inspection, a drive by inspection or other. As one method for gathering table information, the age of improvements may be extracted (automatically or manually) from a property public record file whether public or private:

| | Maximum |
|---|---|
| Calculated | Allowable Age |
| Score | for Drive By |
| 70 to 80 | 30 years |
| 60 to 69 | 20 years |
| 50 to 59 | 10 years |
| 40 to 49 | 5 years |
| 0 to 39 | 0 years |

Once all calculations are complete, a confirmation screen can be displayed to the user indicating whether or not the certificate was granted. The score will also be displayed on the screen. If the Collateral Evaluation Certification was not granted, the maximum acceptable value may also be displayed to the user.

The user will also be given functionality with which to accept the certificate. This will trigger the order for the risk-adjusted verification. The acceptance functionality must allow the user to accept the certificate at a point of time after the check has been run. This will allow the user to confirm with the borrower that the value is acceptable.

While the above description contains various preferred, exemplary, and other specific embodiments, these should not be construed as limitations on the scope of the invention, but as exemplifications of the presently preferred embodiments thereof. Many other ramifications and variations are possible within the teaching of the invention. Thus the scope of the invention should be determined by the appended claims and their legal equivalents, and not solely by the examples given.

I claim:

1. A computer implemented system for converting loan risk and property database information into a risk-adjusted value and report comprising:
a. a software module configured with instructions to retrieve electronic property value data from one or more electronic property value and property characteristic databases and calculate a property value estimate;
b. a software module configured with instructions to retrieve electronic loan risk data from one or more electronic loan information databases to create a loan risk value estimate;
c. a software module configured with instructions to calculate a collateral risk score based on a combination of the property value and loan risk value estimates;
d. A software module with instructions to generate an electronic collateral risk evaluation report with the collateral risk score.

2. The computer implemented system of claim 1 further comprising:
a. a software module with instructions that calculates a variance based on the combined collateral risk score; and
b. a software module with instructions that conditions approval of an electronically submitted evaluation order based on whether a given qualifying value falls within the calculated variance.

3. The computer implemented system of claim 1 wherein the loan risk data comprise loan type, creditworthiness, loan to value ratios, geographical information, loan amount, property characteristics, or sales histories.

4. The computer implemented system of claim 1 further comprising a verification software module with instructions to verify whether an electronically submitted risk evaluation order has been previously submitted within a predetermined timeframe.

5. The computer implemented system of claim 1 further comprising:
a. a software module with instructions to calculate a variance based on the combined collateral risk score;
b. a software module with instructions to condition approval of an electronically submitted evaluation order based on whether or not a given qualifying value falls within the calculated variance; and
c. a software module with instructions to calculate the percentage of difference between the qualifying value and a limit of the calculated variance.

6. The computer implemented system of claim 1 further comprising a software module with instructions to calculate a condition for final approval based on additionally entered limiting conditions.

7. A computer implemented method for converting electronic loan risk and property data into a risk-adjusted value and report, comprising the steps of:
a. Electronically retrieving property value data from one or more electronic property value and property characteristic databases and calculating a property value estimate from that data;
b. Electronically retrieving loan risk data associated with a property from one or more electronic loan information databases and creating a loan risk value estimate from that data;
c. Calculating a collateral risk score based on a combination of the property value and loan risk value estimates;
d. Generating an electronic collateral risk evaluation report with the collateral risk score.

8. The method of claim 7 further comprising the steps of:
a. Calculating a variance based on the combined collateral risk score; and
b. Conditioning approval of an electronically submitted evaluation order based on whether or not a given qualifying value falls within the calculated variance.

9. The method of claim 7 wherein the loan risk data includes loan type, creditworthiness, loan to value ratios, geographical information, loan amount, or sales histories.

10. The method of claim 7 further comprising the step of verifying whether an electronically submitted risk evaluation order has been previously submitted within a predetermined timeframe.

11. The method of claim 7 further comprising the steps of:
a. Calculating a variance based on the combined collateral risk score;
b. Conditioning approval of an electronically submitted evaluation order based on whether or not a given qualifying value falls within the calculated variance; and
c. Calculating the percentage of difference between the qualifying value and a limit of the calculated variance.

12. The method of claim 7 further the step of conditioning final approval of an electronically submitted evaluation order on additional limiting conditions electronically submitted to the software program.

13. A computer readable medium comprising code executable by a computing device for causing said computing device to convert electronic loan risk and property data into a risk-adjusted value and report, comprising the steps of:
a. Executing code to retrieve electronic property value data from one or more electronic property value and property characteristic databases and calculating a property value estimate from that data;
b. Executing code to retrieve electronic loan risk data associated with a property from electronic loan information databases and creating a loan risk value estimate from that data;
c. Executing code to calculate a collateral risk score based on a combination of the property value and loan risk value estimates;
d. Executing code to generate an electronic collateral risk evaluation report with the collateral risk score.

14. The computer readable medium of claim 13 further comprising the steps of:
a. Executing code to calculate a variance based on the combined collateral risk score; and
b. Executing code that conditions approval of an electronically submitted evaluation order based on whether a given qualifying value falls within the calculated variance.

15. An apparatus comprising:
a. Means for retrieving electronic property value data from one or more electronic property value relational databases and calculating a property value estimate
b. Means for retrieving electronic loan risk data from one or more electronic loan information relational databases and creating a loan risk value estimate;
c. Means for calculating a collateral risk score based on a combination of the property value and loan risk value estimates;
d. Means for c generating an electronic collateral risk evaluation report with the collateral risk score.

16. The apparatus of claim 14 further comprising:
a. Means for calculating a variance based on the combined collateral risk score; and
b. Means for conditioning approval of an electronically submitted evaluation order based on whether a given qualifying value falls within the calculated variance.

17. The apparatus of claim 15 wherein the loan risk data include loan type, creditworthiness, loan to value ratios, geographical information, loan amount, or sales histories.

18. The apparatus of claim 14 further comprising means for verifying whether an electronically submitted risk evaluation order has been previously submitted within a predetermined timeframe.

19. The apparatus of claim 14 further comprising
a. Means for calculating a variance based on the combined collateral risk score;
b. Means for conditioning approval of an electronically submitted evaluation order based on whether or not a given qualifying value falls within the calculated variance; and
c. Means for calculating the percentage of difference between the qualifying value and a limit of the calculated variance.

20. The apparatus of claim 14 further comprising means for calculating a condition for final approval based on additionally entered limiting conditions.
